(19) United States
(12) Patent Application Publication
(10) Pub. No.: US 2013/0136419 A1
(43) Pub. Date: May 30, 2013

(54) SOCIAL NETWORK BASED RECORDING

(71) Applicants: Tim Herby, Los Altos, CA (US); Antonio Fontan, San Jose, CA (US); Alan Merzon, San Jose, CA (US); Christopher Habliston, San Jose, CA (US)

(72) Inventors: Tim Herby, Los Altos, CA (US); Antonio Fontan, San Jose, CA (US); Alan Merzon, San Jose, CA (US); Christopher Habliston, San Jose, CA (US)

(73) Assignee: MICROSOFT CORPORATION, Redmond, WA (US)

(21) Appl. No.: 13/305,600

(22) Filed: Nov. 28, 2011

(51) Int. Cl. H04N 9/80

(52) U.S. Cl. 386/243; 386/E05.003

(57) ABSTRACT

According to one aspect of this disclosure, information is received indicating a set of content items that a first user intends to record. The set of content items are automatically added to a recording schedule of a second user, where the recording schedule indicates content items that are scheduled to be recorded. An indication that an additional content item has been added or removed to the set of content items may be received, and, the additional content item is automatically added or removed to the recording schedule of the second user.

### BACKGROUND

Watching television and movie programs can be a social experience. People often spend significant time and energy sharing thoughts and opinions related to television and movie programs. Typically, if a person hears of a potentially interesting program, that person can find that program on her own to view later. However, it can be difficult to remember the programs one hears about, and finding such programs may be laborious and time consuming.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, a set of content items that a first user intends to record is automatically added to a recording schedule of a second user. If the first user adds content items to the set, those additional content items are automatically added to the recording schedule of the second user.

### BRIEF DESCRIPTION OF THE DRAWINGS

FIG. 1 schematically shows an example system in which recording schedules may be maintained and utilized.

FIG. 2 schematically shows an example content item.

FIG. 3 shows an example method for creating and maintaining recording schedules.

FIG. 4 schematically shows an example first user recording schedule.

FIG. 5 schematically shows an update to a second user recording schedule based on the first user recording schedule of FIG. 4.

FIG. 6 shows another example method for creating and maintaining recording schedules.

FIG. 7 schematically shows an update to the second user recording schedule of FIG. 5.

FIG. 8 shows an example computing system for performing the method of FIG. 3.

### DETAILED DESCRIPTION

Content recording devices, such as digital video recorders (DVRs), may utilize social networking services to automatically update recording schedules. In this way, a recording schedule controls which content items a recording device records based at least in part on the content items that have been added to the recording schedule(s) of one or more socially connected friends. Items that can be recorded in this way may include virtually any audio-visual content (e.g., television shows, movies, and/or webcasts).

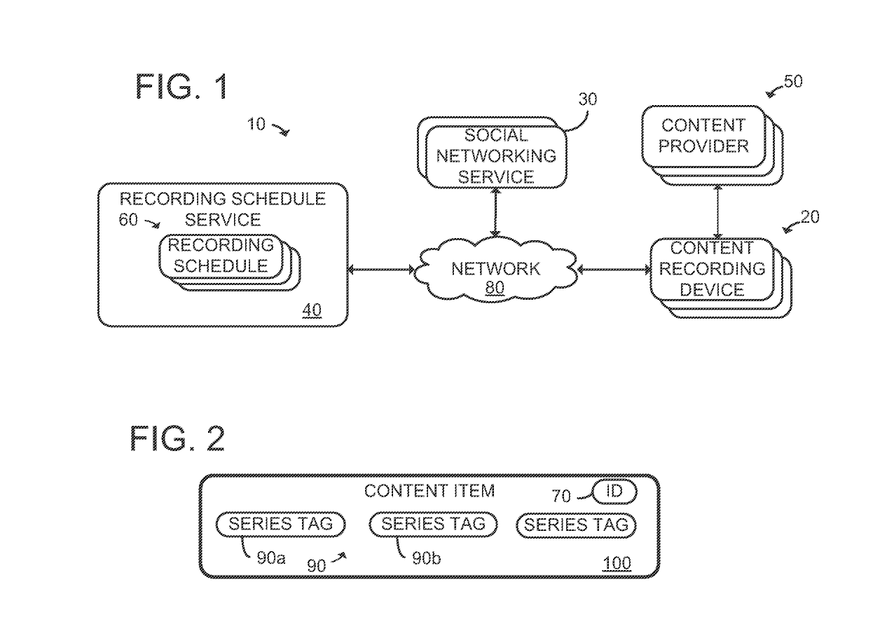

FIG. 1 schematically shows a system 10 for creating and using recording schedules 60. System 10 includes content recording devices 20, social networking services 30, recording schedule service 40, and content providers 50, which may share information via a network 80, such as the Internet. While recording schedule service 40 is illustrated as being remotely located relative to content recording devices 20, it is to be understood that each content recording device may include a client-side scheduler—i.e., recording schedule service 40 may be integrated with a client device 20.

Content recording devices 20 are configured to receive and record content items from content providers 50. A content item may include virtually any audio-visual content, such as a television show, a webcast, a radio show, or a movie, for example. The content items may be delivered to the content recording devices 20 via any suitable transmission mechanism, including but not limited to over-the-air broadcasts, cable broadcasts, satellite broadcasts, and/or Internet broadcasts. Content providers 50 may provide such content items for free, as part of a subscription package, on an ‘on demand’ basis, or via virtually any other distribution model. It should be appreciated that the content items may be available for viewing from more than one content provider.

Recording schedules 60 may be used to indicate to content recording devices 20 which content items are to be recorded, or, in the case of on-demand content, which content items are to be retrieved from one or more remote locations. Recording schedules 60 may be associated with a particular content recording device and/or a particular user profile. Thus, it is possible to add a content item to a recording schedule 60 so that a particular content recording device 20 will record that content item, or so that more than one content recording device 20 associated with the same user profile will record that content item. It is to be appreciated that recording schedules 60 may contain an indication of content items to be recorded rather than actual content items. Thus, a content item is “added” to a recording schedule by adding an indicator of that content item.

Recording schedule service 40 may maintain, create, and/or modify recording schedules 60. Recording schedule service 40 may have read and/or write access to recording schedules for a plurality of devices and/or users. Recording information from a first user may be used to create, modify and/or maintain a recording schedule of a second user.

In some embodiments, recording schedule service 40 may be located remotely from content recording device 20, and may compile and/or send recording schedules 60 to a plurality of content recording devices 20. In other embodiments, recording schedule service 40 may be located locally with each individual content recording device 20, and the above described recording information from the first user may be sent from one content recording device 20 to a content recording device 20 of the second user, via a network and/or through a social networking service, as described below.

Social networking services 30 may include one or more services that are capable of recognizing a virtual identity of a user (e.g., a user profile) and the social connections of that user (e.g., friend profiles). Social networking services 30 may be utilized by recording schedule service 40. For example, the recording schedule may receive and/or share user information with one or more social networking services via an application programming interface (API) or other suitable mechanism. Social networking services 30 may share virtually any user information, such as recording/viewing habits of a user or a user's social graph, for example. In some embodiments, social networking services 30 may be configured to show which content items a user wishes to share with others. In some embodiments, recording schedule service 40 may be integrated with one or more social networking services.

An example content item 100 is shown schematically in FIG. 2. Content item 100 may have associated metadata including a universal identification code 70 to uniquely identify the content item 100 independent of the content provider 50 which provides the content item 100. By using universal identification codes 70 to identify content items, recording schedules 60 can be utilized by virtually any content recording device 20 with content from virtually any content provider 50.

Content item 100 also includes series tags 90 to identify sets of content items. Series tags 90 may identify the set of content items in that each content item in the set of content items has the same series tag 90. For example, a set of content items related to baseball may all include a series tag 90 indicating that the content item is related to baseball.

It should be appreciated that other tags may be associated with content items for purposes other than defining sets of content items. Such tags may provide information related to the content item, but do not necessarily define a set.

Tags (including series tags 90) may include virtually any information related to content item 100, such as information about the person and/or account that intends to record the content item 100, information about a user's opinion of the content item, or information about the content item itself, for example.

Identification code 70 and/or series tag 90 may be applied to content items 100 via virtually any method. As mentioned above, the identification code and/or series tag 90 may be packaged with the actual content payload as metadata. Alternatively, an identification code and/or series tag 90 may be associated with the content but saved apart from the actual content payload. Series tag 90 may include two categories of series tags, user-input series tags 90a and automatically-generated series tags 90b. In some embodiments, a user-input series tag 90a may be applied to a content item 100 via an explicit input from a user. The input may include information defining the user-input series tag 90a.

A user may apply tags (e.g. user-input series tag 90a) via virtually any suitable user interface, such as a user interface implemented by content recording device 20 or social networking services 30, for example. The user interface may provide options for applying a tag to a content item 100, such as showing a list of possible tags, or by allowing a user to define a new tag. It should be appreciated that virtually any tag may be applied by a user to a content item 100, and content item 100 may include a virtually unlimited amount of different tags. Additionally or alternatively, a tag may be applied to the series that caused the content item 100 to be generated.

In some embodiments, at least one automatically-generated series tag 90b is automatically applied to a content item without an explicit user input defining the series tag 90. For example, a user may add a content item 100 to a recording schedule 60, and in response, an automatically-generated series tag 90b indicative of the user's identity may be automatically associated with that content item. The user's identity may be known via a log in mechanism, or based on the recording schedule 60 to which the content item 100 has been added. Other types of tags, such as metadata tags, may be automatically applied, such as tags based on the type of content item (e.g. movie, TV show, webcast), the length of the content item, a rating (e.g. R, PG-13), a genre (e.g. comedy, news, drama), etc.

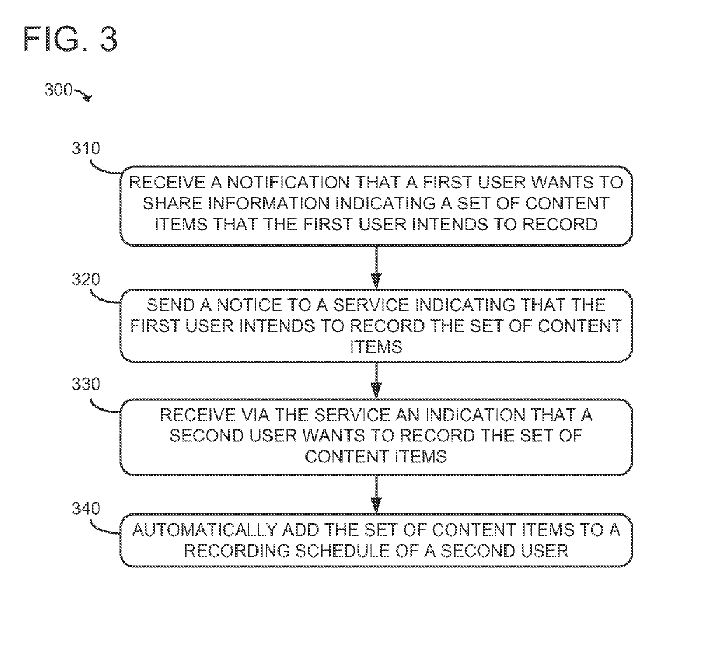

Turning to FIG. 3, FIG. 3 shows a method 300 to create, modify and/or maintain recording schedules. The method 300 may be implemented via recording schedule service 40 or content recording devices 20, for example.

The method 300 may include, at 310, receiving a notification that a first user wants to share information indicating a set of content items that the first user intends to record. The notification may be received via virtually any communication channel, in response to virtually any user action. For example, the first user may be prompted to share a content item upon adding the set of content items to a recording schedule. If the first user responds affirmatively to the prompt, the notification may be received. It is to be understood that the intentions of the user are inferred by the data and/or settings of that user's account. As such, the set of content items a user intends to record can be determined by the data and/or settings of that user's accounts.

In some embodiments, the first user may explicitly send the notification. For example, a first user may indicate (via the first user's content recording device 20, recording schedule service 40, and/or social networking services 30, for example) that they wish to share a set of content items related to baseball. In such a scenario, a notification indicating that the first user wants to share information indicating the set of baseball related content items may be received. The set of content items may be identified via a common series tag 90, as described above.

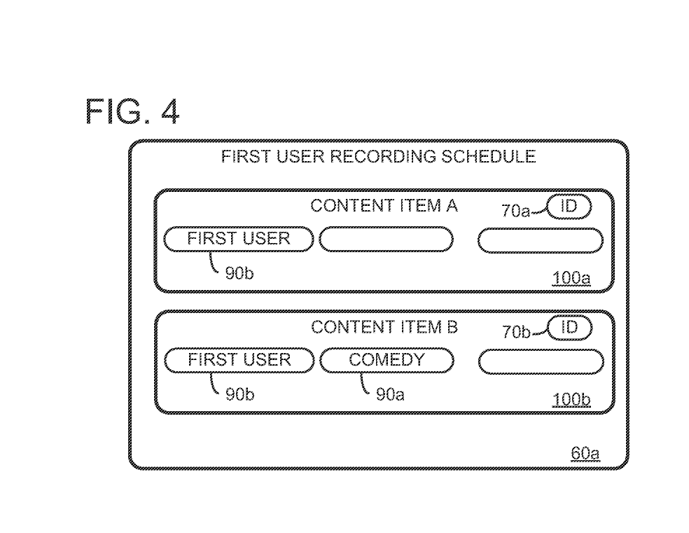

Turning briefly to FIG. 4, FIG. 4 shows an example first user recording schedule 60a, including content items 100a and 100b, identified via identification codes 70a and 70b. Content items 100a and 100b may each include an automatically-generated series tag 90b, while content item 100b may also include a user-input series tag 90a, to denote that content item 100b is a comedy item. The first user may want to share a set of content items in recording schedule 60a. For example, the first user may want to share a set of comedy items, which in the depicted embodiment would include content item 100b, indicated by user-input series tag 90a. It should be appreciated that more than one content item may be included in the set of content items. For example, one or more other content items may also be tagged with user-input series tag 90a, thus signaling that such content items are to be included in the set of content items.

Turning back to FIG. 3, the method 300 may include, at 320, sending a notice to a social networking service indicating that the first user intends to record the set of content items. Such a service may be social networking service 30 of FIG. 1, for example. The social networking service may then share with others that the first user intends to record the set of content items. Sharing may be implemented by posting the information on a web site, for example. In this way, the intention to record the first set of content items may be shared with a virtually unlimited amount of people, with minimal user effort. The intent may be shared with all or a subset of socially connected friends on the first user's social graph, for example.

The method 300 may include, at 330, receiving, via the social networking service, an indication that a second user wants to record the set of content items. The indication may be received because a second user has noticed that the set of content items is interesting, and also wants to record that set of content items. The indication may be received in response to input by the second user, such as the second user clicking a hyperlink that the service has provided, for example. The social networking service may also be configured to alert the first user that the second user wishes to subscribe to their content items. In this way, the first user may receive positive feedback for sharing their content items.

The method 300 may include, at 340, automatically adding the set of content items to a recording schedule of a second user. Thus, the second user can automatically benefit from the content items that his or her friend is watching.

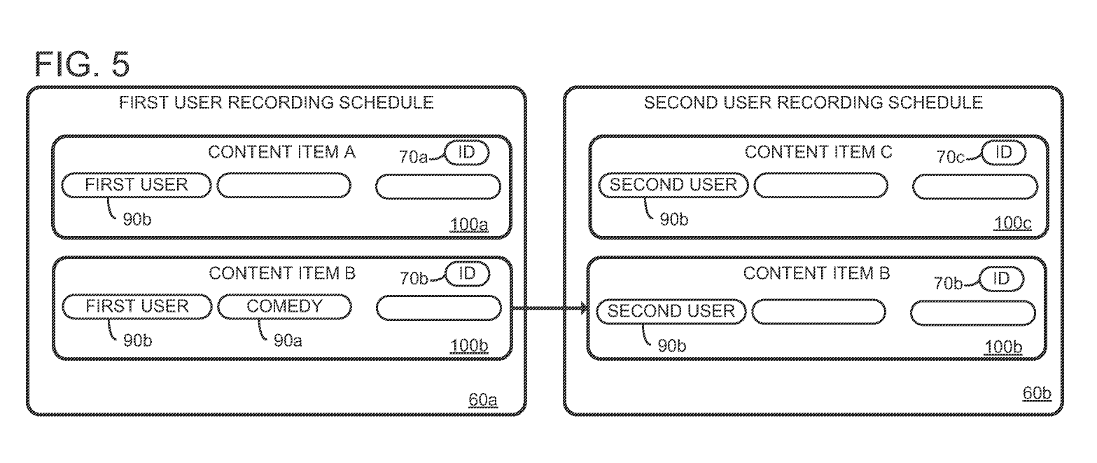

Turning briefly to FIG. 5, FIG. 5 shows the example first user recording schedule 60a, as well as an example second user recording schedule 60b including content items 100b and 100c (content item 100c is identified via identification code 70c). As shown, content item 100b has been automatically added to the second user recording schedule 60b. Also, automatically-generated series tag 90b has been automatically added to that content item, to reflect that the second user intends to record that content item. In the depicted embodiment, the content item 100b includes the automatically-generated series tag 90b in both the first and second user recording schedules 60a and 60b. Additionally, only the content item 100b of the recording schedule 60a of the first user may include the user-input series tag 90a, and the content item 100b of the recording schedule 60b of the second user may not include this series tag, unless the second user creates his or her own user-input series tag 90a for this content item 100b. In this way, user-input series tags 90a may not carry over from one user to another, but each user may select which user-input series tags 90a to associate with which content items.

In some embodiments, the first user may change the set of content items by adding content items with the same series tag 90, by deleting content items, or by applying the same series tag 90 to a content item already in their recording schedule, for example. The second user's recording schedule may reflect these changes, automatically adding and/or removing content items to mirror the content items from the shared set of the first user. In other words, the second user subscribes to a selected set of content items selected by the first user.

Method 300 is a nonlimiting example of a method that a second user may utilize to subscribe to a set of content items selected by a first user. In other embodiments, the second user may send a request (e.g., via social networking service 30) asking permission to subscribe to a first user's programming. In yet another embodiment, the first user may indicate that anybody is allowed to subscribe to a selected set of content items. It is to be understood that a subscription to all or part of the recording schedule of another user may be initiated in virtually any manner without departing from the scope of this disclosure.

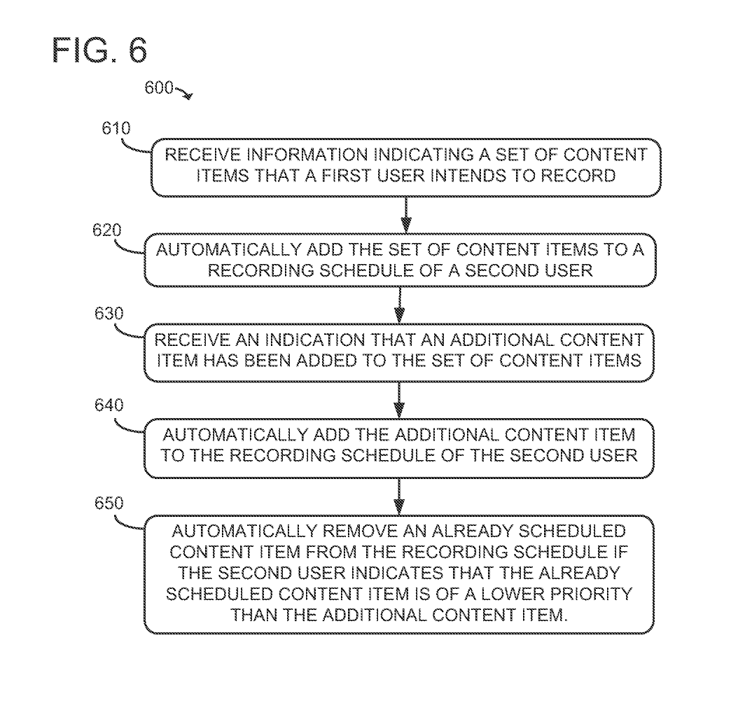

Turning to FIG. 6, FIG. 6 shows an example method 600 for maintaining a subscription to a first user's recording schedule. The method 600 may include, at 610, receiving information (e.g., a tag) indicating a set of content items that a first user intends to record. Such information may be received according to elements of method 300, such as via social networking service 30, for example. In some embodiments, the information may be received by looking up the recording schedule of the first user, and finding which content items are in the set of content items by parsing series tags.

The method 600 may include, at 620, automatically adding the set of content items to a recording schedule of a second user. In this way, one or more devices of the second user will automatically record the content items because the same content items are to be recorded by the first user. In some embodiments, a message may be sent to the second user indicating that a content item has been added to the set of content items.

The method 600 may include, at 630, receiving an indication that an additional content item has been added to the set of content items of the first user. An additional content item may be added to the set of content items in virtually any way. For example, the first user may decide to record another content item, and tag that content item to be included in the same set of content items to which the second user subscribes. The new content item can be added to the set automatically, for example, by virtue of aspects identifiable by metadata associated with the content item. The new content item can alternatively be added manually, for example because the first user specifically identifies it for inclusion as part of the set to which the second user subscribes.

In some embodiments, the indication that an additional content item has been added is received automatically as soon as a user adds an additional content item. For example, the first user may begin watching and/or recording a content item that is currently being broadcast, and in response to this viewing, an indication may be sent. In other embodiments, indication that an additional content item has been added may not occur immediately, but may occur on a schedule, e.g., once a day.

The method 600 may include, at 640, automatically adding the additional content item to the recording schedule of the second user. Automatically adding additional content items allows a second user to subscribe to a set of content items of a first user, so that the second user may have content items added with minimal or no intervention. As introduced above, an indication that a new content item has been added to a set may be sent and received in response to a first user watching and/or recording a currently broadcasting content item. In such scenarios, one or more devices of the second user may immediately begin to automatically record the content item. In some embodiments, if the additional content item that is added to the content set of the first user is a currently airing content item, e.g., a television program that is airing at the time the content item is added, the currently airing content item may not be immediately added, but a complete re-broadcast of the content item may be added. In another embodiment, if the additional content item is currently airing, the remainder of the content item (e.g., the portion of the content item that has yet to air) can be immediately added but replaced with a complete re-broadcast of the content item when the re-broadcast becomes available at a later time.

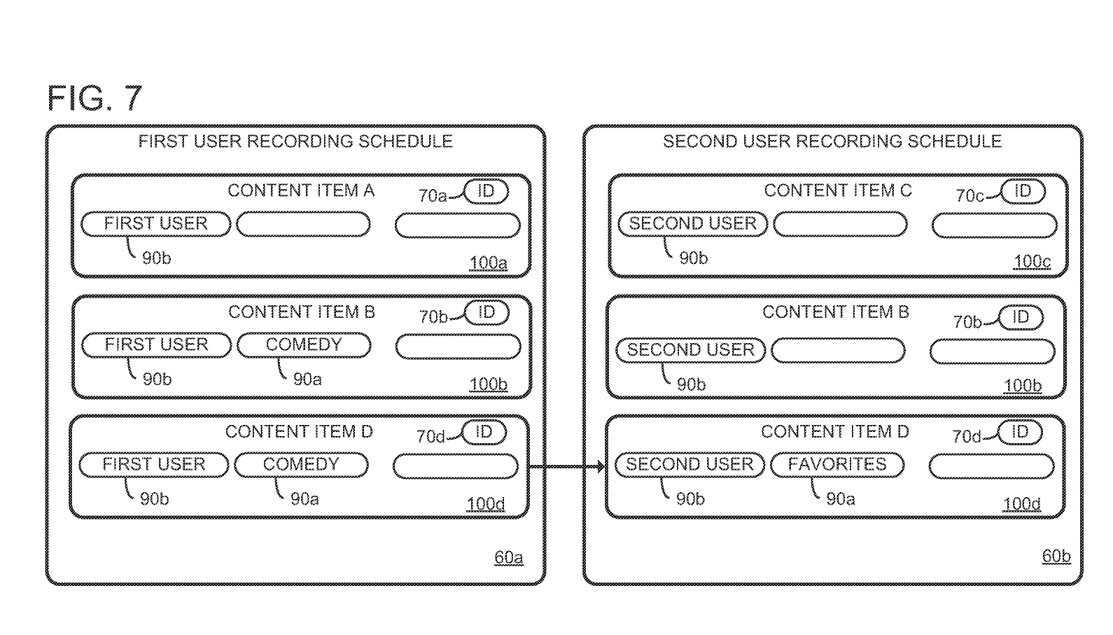

Turning briefly to FIG. 7, FIG. 7 shows the example recording schedules 60a and 60b of a first and second user. An additional content item 100d has been added to the set of content items identified by automatically-generated series tag 90b ‘FIRST USER’ and user-input series tag 90a ‘COMEDY’ in the first user recording schedule 60a. The second user may be subscribed to the set of content items identified by series tag 90b ‘FIRST USER’ and/or series tag 90a ‘COMEDY.’ According to method 600, the additional content item 100d is then automatically added to the second user recording schedule 60b. Content item 100d may be identified via identification code 70d. In the depicted embodiment, the additional content item 100d may include the user-input series tag 90a ‘FAVORITES’ to denote that the content item is a favorite item of the second user. However, this tag is input by the second user, and does not automatically appear. As such, without inputting the tag, the content item may not be tagged with the user-input tag 90a, as with the content item 100b, which does not include user-input series tag 90a. The user-input series tags 90a ‘FAVORITES’ may allow the second user to share the content item 100d with other users who subscribe to the second user's set of content items.

In one possible scenario, a second user may not be able to record two content items at the same time. For example, a user's content provider may be configured to provide only one content item at a time. As such, two content items scheduled to be recorded at the same time may cause a conflict.

The method 600 may include, at 650, automatically removing an already scheduled content item from the recording schedule if the second user indicates that the already scheduled content item is of a lower priority than the additional content item. Optionally, the lower priority content item may not be added to the recording schedule.

The second user may indicate content item priorities in virtually any way. For example, the second user may indicate that all shows from a “comedy” subscription should have a higher priority than shows from a “news” subscription, or that all programs the second user personally adds to the recording schedule have a higher priority than any programs added only because of a subscription to a set of another user. As another example, the second user may configure the recording schedule service 40 such that content items from a particular subscription have a higher priority than content items from a different subscription. Thus, a user may record only the most desired content items.

In some embodiments, a user is notified if a scheduling conflict has occurred. A user may then take action to resolve the scheduling conflict, such as by setting a priority, picking an alternate time at which the content item airs at which to record, or manually removing a content item from the recording schedule.

In some embodiments, duplicate recordings of content items are reconciled automatically. Duplicate recordings may occur if a user is subscribing to more than one set of content items, and each set includes a common content item. In such a case, the content item may be recorded only once, yet may be associated with both sets of content items. In other words, although the content item is recorded once, it may still appear to a user to be recorded as part of both of the sets of content items to which that user is subscribing. Additionally, content items that the user has personally selected for recording may overlap with content items to which that user is subscribing, and such overlapping items may only be recorded once.

In some embodiments, content providers may be configured to provide more than one version of a content item. For example, a content item may be available in a variety of languages, different resolutions, and/or at different times. A user may specify a preference to record a certain version of a content item, such as a high-definition version, as opposed to a standard-definition version, for example.

It should be appreciated that a change to a set of content items a first user may affect recording schedules of an unlimited amount of other users. For example, a set of content items may be subscribed to by a second user and included in a set of the second user, and that second user's set, or part of that set, may be subscribed to by a third user, a fourth user, and so on, such that a change made by the first user may have a cascading effect.

A user may optionally limit what content items are automatically added to a recording schedule. As one example, a user may specify that any content item with a specified metadata tag (e.g. ‘adult’, ‘R-rated’, ‘cycling’) is not to be added to the recording schedule. Thus even if that user's system is configured to record content items based on a subscription, certain content items from the subscription may be blacklisted so as to never be recorded.

Recording schedule service 40 may perform other operations as well. For example, recording schedule service 40 may provide functions to search for content items, alert users when new content items become available, or make suggestions as to what content items a user may want to add to a recording schedule. In some embodiments, recording schedule service 40 may allow a user to browse other user's recording schedules, without adding content items to their own recording schedule.

In some embodiments, the above described methods and processes may be tied to a computing system including one or more computers. In particular, the methods and processes described herein may be implemented as a computer application, computer service, computer API, computer library, and/or other computer program product.

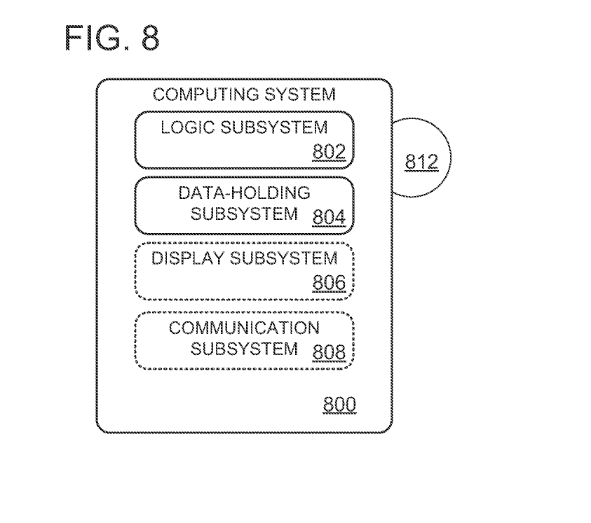

FIG. 8 schematically shows a nonlimiting computing system 800 that may perform one or more of the above described methods and processes. Computing system 800 is shown in simplified form. It is to be understood that virtually any computer architecture may be used without departing from the scope of this disclosure. In different embodiments, computing system 800 may take the form of a mainframe computer, server computer, desktop computer, laptop computer, tablet computer, home entertainment computer, network computing device, mobile computing device, mobile communication device, gaming device, etc. Content recording device 20, social networking service 30, and/or recording schedule service 40 may optionally take the form of one or more of the below described computing system 800.

Computing system 800 includes a logic subsystem 802 and a data-holding subsystem 804. Computing system 800 may optionally include a display subsystem 806, communication subsystem 808, and/or other components not shown in FIG. 8. Computing system 800 may also optionally include user input devices such as remote controls, keyboards, mice, game controllers, cameras, microphones, and/or touch screens, for example.

Logic subsystem 802 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 804 may include one or more physical, non-transitory, devices configured to hold data and/or instructions executable by the logic subsystem to implement the herein described methods and processes. When such methods and processes are implemented, the state of data-holding subsystem 804 may be transformed (e.g., to hold different data).

Data-holding subsystem 804 may include removable media and/or built-in devices. Data-holding subsystem 804 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 804 may include devices with one or more of the following characteristics: volatile, nonvolatile, dynamic, static, read/write, read-only, random access, sequential access, location addressable, file addressable, and content addressable. In some embodiments, logic subsystem 802 and data-holding subsystem 804 may be integrated into one or more common devices, such as an application specific integrated circuit or a system on a chip.

FIG. 8 also shows an aspect of the data-holding subsystem in the form of removable computer-readable storage media 812, which may be used to store and/or transfer data and/or instructions executable to implement the herein described methods and processes. Removable computer-readable storage media 812 may take the form of CDs, DVDs, HD-DVDs, Blu-Ray Discs, EEPROMs, and/or floppy disks, among others.

It is to be appreciated that data-holding subsystem 804 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

It is to be appreciated that a “service”, as used herein, may be an application program executable across multiple user sessions and available to one or more system components, programs, and/or other services. In some implementations, a service may run on a server responsive to a request from a client, or may run locally on the client device. In some embodiments, multiple services may be combined into a single, integrated service.

When included, display subsystem 806 may be used to present a visual representation of data held by data-holding subsystem 804. As the herein described methods and processes change the data held by the data-holding subsystem, and thus transform the state of the data-holding subsystem, the state of display subsystem 806 may likewise be transformed to visually represent changes in the underlying data. Display subsystem 806 may include one or more display devices utilizing virtually any type of technology. Such display devices may be combined with logic subsystem 802 and/or data-holding subsystem 804 in a shared enclosure, or such display devices may be peripheral display devices.

When included, communication subsystem 808 may be configured to communicatively couple computing system 800 with one or more other computing devices. Communication subsystem 808 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 800 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A data-holding subsystem holding instructions executable by a logic subsystem to:
receive information indicating a set of content items that a first user intends to record; and
automatically add the set of content items to a recording schedule of a second user, the recording schedule indicating content items that are scheduled to be recorded.

2. The data-holding subsystem of claim 1, where each content item has associated metadata including a universal identification code to uniquely identify the content item independent of a content provider which provides the content item.

3. The data-holding subsystem of claim 1, where all content items in the set of content items include a series tag which identifies the set of content items.

4. The data-holding subsystem of claim 3, where at least one of the series tags is applied to a content item in the set of content items via an explicit input from the first user, the input including information defining the series tag.

5. The data-holding subsystem of claim 3, where at least one of the series tags is automatically applied to a content item in the set of content items, without an explicit user input defining the series tag.

6. The data-holding subsystem of claim 1, where the content items are available for recording from more than one content provider.

7. The data-holding subsystem of claim 1, further holding instructions executable by the logic subsystem to:
receive an indication that an additional content item has been added to the set of content items or that an already scheduled content item has been removed from the set of content items; and
in accordance with the indication, automatically add the additional content item to the recording schedule of the second user or remove the already scheduled content item from the recording schedule of the second user.

8. A method for maintaining a recording schedule, the method including:
receiving information indicating a set of content items that a first user intends to record;
automatically adding the set of content items to a recording schedule of a second user, the recording schedule being utilized by a content recording device to record content to the recording device;
receiving an indication that an additional content item has been added to the set of content items or that an already scheduled content item has been removed from the set of content items; and
in accordance with the indication, automatically adding the additional content item to the recording schedule of the second user or removing the already scheduled content item from the recording schedule of the second user.

9. The method of claim 8, where each content item has associated metadata including a universal identification code to uniquely identify the content item independent of a content provider which provides the content item.

10. The method of claim 8, where all content items in the set of content items include a series tag which identifies the set of content items.

11. The method of claim 10, where at least one of the series tags is applied to a content item in the set of content items via an explicit input from the first user, the input including information defining the series tag.

12. The method of claim 10, where at least one of the series tags is automatically applied to a content item in the set of content items, without an explicit user input defining the series tag.

13. The method of claim 8, where the content items are available for recording from more than one content provider.

14. A data-holding subsystem holding instructions executable by a logic subsystem to:
receive a notification that a first user wants to share information indicating a set of content items that the first user intends to record;
send a notice to a social networking service indicating that the first user intends to record the set of content items;
receive via the social networking service an indication that a second user wants to record the set of content items; and
automatically add the set of content items to a recording schedule of the second user.

15. The data-holding subsystem of claim 14, further holding instructions executable by the logic subsystem to:
receive an indication that an additional content item has been added to the set of content items; and
automatically add the additional content item to the recording schedule of the second user.

16. The data-holding subsystem of claim 14, further holding instructions executable by the logic subsystem to:
receive an indication that an already scheduled content item has been removed from the set of content items; and
automatically remove the already scheduled content item from the recording schedule of the second user.

17. The data-holding subsystem of claim 14, where each content item has associated metadata including a universal identification code to uniquely identify the content item independent of a content provider which provides the content item.

18. The data-holding subsystem of claim 14, where all content items in the set of content items include a series tag which identifies the set of content items.

20. The data-holding subsystem of claim 14, where the content items are available for recording from more than one content provider.
